(19) United States
(12) Patent Application Publication
(10) Pub. No.: US 2025/0058648 A1
(43) Pub. Date: Feb. 20, 2025

(54) AN AUTOMATED STORAGE AND RETRIEVAL SYSTEM AND A METHOD OF OPERATING SUCH AN AUTOMATED STORAGE AND RETRIEVAL SYSTEM

(71) Applicant: AutoStore Technology AS, Nedre Vats (NO)

(72) Inventor: Svein Engelsgjerd, Etne (NO)

(21) Appl. No.: 18/718,153

(22) PCT Filed: Dec. 5, 2022
(86) PCT No.: PCT/EP2022/084440

§ 371 Date: Jun. 10, 2024

(30) Foreign Application Priority Data
Dec. 17, 2021 (NO) 20211533

(51) Int. Cl. B60L 15/20; B65G 1/06

(52) U.S. Cl. CPC B60L 15/2045; B65G 1/065; B60L 2240/427; B60L 2240/429; B60L 2260/54

(57) ABSTRACT

The invention relates to a method of operating an automated storage and retrieval system (1), the method comprising using a device (600) of the automated storage and retrieval system (1) to calculate energy used by the device (600). The invention further relates to an automated storage and retrieval system (1) with an energy manager.

The present invention relates primarily to a method of operating an automated storage and retrieval system.

### BACKGROUND AND PRIOR ART

FIG. 1 discloses a prior art automated storage and retrieval system 1 with a framework structure 100 and FIGS. 2, 3a-3b disclose three different prior art container handling vehicles 201, 301, 401 suitable for operating on such a system 1.

The framework structure 100 comprises upright members 102 and a storage volume comprising storage columns 105 arranged in rows between the upright members 102. In these storage columns 105 storage containers 106, also known as bins, are stacked one on top of one another to form container stacks 107. The members 102 may typically be made of metal, e.g. extruded aluminum profiles.

The framework structure 100 of the automated storage and retrieval system 1 comprises a rail system 108 arranged across the top of framework structure 100, on which rail system 108 a plurality of container handling vehicles 301, 401 may be operated to raise storage containers 106 from, and lower storage containers 106 into, the storage columns 105, and also to transport the storage containers 106 above the storage columns 105. The rail system 108 comprises a first set of parallel rails 110 arranged to guide movement of the container handling vehicles 301, 401 in a first direction X across the top of the frame structure 100, and a second set of parallel rails 111 arranged perpendicular to the first set of rails 110 to guide movement of the container handling vehicles 301, 401 in a second direction Y which is perpendicular to the first direction X. Containers 106 stored in the columns 105 are accessed by the container handling vehicles 301, 401 through access openings 112 in the rail system 108. The container handling vehicles 301, 401 can move laterally above the storage columns 105, i.e. in a plane which is parallel to the horizontal X-Y plane.

The upright members 102 of the framework structure 100 may be used to guide the storage containers during raising of the containers out from and lowering of the containers into the columns 105. The stacks 107 of containers 106 are typically self-supportive.

Each prior art container handling vehicle 201, 301, 401 comprises a vehicle body 201a, 301a, 401a and first and second sets of wheels 201b, 201c, 301b, 301c, 401b, 401c which enable lateral movement of the container handling vehicles 201, 301, 401 in the X direction and in the Y direction, respectively. In FIGS. 2-3b, two wheels in each set are fully visible. The first set of wheels 201b, 301b, 401b is arranged to engage with two adjacent rails of the first set 110 of rails, and the second set of wheels 201c, 301c, 401c is arranged to engage with two adjacent rails of the second set 111 of rails. At least one of the sets of wheels 201b, 201c, 301b, 301c, 401b, 401c can be lifted and lowered, so that the first set of wheels 201b, 301b, 401b and/or the second set of wheels 201c, 301c, 401c can be engaged with the respective set of rails 110, 111 at any one time.

Each prior art container handling vehicle 201, 301, 401 also comprises a lifting device 304, 404 (visible in FIGS. 3a-3b) having a lifting frame part 304a for vertical transportation of storage containers 106, e.g. raising a storage container 106 from, and lowering a storage container 106 into, a storage column 105. Lifting bands 404a are also shown. The lifting device 304, 404 comprises one or more gripping/engaging devices which are adapted to engage a storage container 106, and which gripping/engaging devices can be lowered from the vehicle 201, 301, 401 so that the position of the gripping/engaging devices with respect to the vehicle 201, 301, 401 can be adjusted in a third direction Z (visible for instance in FIG. 1) which is orthogonal the first direction X and the second direction Y. Parts of the gripping device of the container handling vehicles 301, 401 are shown in FIGS. 3a and 3b indicated with reference number. The gripping device of the container handling device 201 is located within the vehicle body 201a in FIG. 2.

Conventionally, and also for the purpose of this application, Z=1 identifies the uppermost layer available for storage containers below the rails 110, 111, i.e. the layer immediately below the rail system 108, Z=2 the second layer below the rail system 108, Z=3 the third layer etc. In the exemplary prior art disclosed in FIG. 1, Z=8 identifies the lowermost, bottom layer of storage containers. Similarly, X=1 . . . n and Y=1 . . . n identifies the position of each storage column 105 in the horizontal plane. Consequently, as an example, and using the Cartesian coordinate system X, Y, Z indicated in FIG. 1, the storage container identified as 106′ in FIG. 1 can be said to occupy storage position X=18, Y=1, Z=6. The container handling vehicles 201, 301, 401 can be said to travel in layer Z=0, and each storage column 105 can be identified by its X and Y coordinates. Thus, the storage containers shown in FIG. 1 extending above the rail system 108 are also said to be arranged in layer Z=0.

The storage volume of the framework structure 100 has often been referred to as a grid 104, where the possible storage positions within this grid are referred to as storage cells. Each storage column may be identified by a position in an X- and Y-direction, while each storage cell may be identified by a container number in the X-, Y- and Z-direction.

Each prior art container handling vehicle 201, 301, 401 comprises a storage compartment or space for receiving and stowing a storage container 106 when transporting the storage container 106 across the rail system 108. The storage space may comprise a cavity arranged internally within the vehicle body 201a as shown in FIGS. 2 and 3b and as described in e.g. WO2015/193278A1 and WO2019/206487A1, the contents of which are incorporated herein by reference.

FIG. 3a shows an alternative configuration of a container handling vehicle 301 with a cantilever construction. Such a vehicle is described in detail in e.g. NO317366, the contents of which are also incorporated herein by reference.

The cavity container handling vehicles 201 shown in FIG. 2 may have a footprint that covers an area with dimensions in the X and Y directions which is generally equal to the lateral extent of a storage column 105, e.g. as is described in WO2015/193278A1, the contents of which are incorporated herein by reference. The term ‘lateral’ used herein may mean ‘horizontal’.

Alternatively, the cavity container handling vehicles 401 may have a footprint which is larger than the lateral area defined by a storage column 105 as shown in FIG. 3b and as disclosed in WO2014/090684A1 or WO2019/206487A1.

The rail system 108 typically comprises rails with grooves in which the wheels of the vehicles run. Alternatively, the rails may comprise upwardly protruding elements, where the wheels of the vehicles comprise flanges to prevent derailing. These grooves and upwardly protruding elements are collectively known as tracks. Each rail may comprise one track, or each rail may comprise two parallel tracks; in other rail systems 108, each rail in one direction may comprise one track and each rail in the other perpendicular direction may comprise two tracks. The rail system may also comprise a double track rail in one of the X or Y direction and a single track rail in the other of the X or Y direction. A double track rail may comprise two rail members, each with a track, which are fastened together.

WO2018/146304A1, the contents of which are incorporated herein by reference, illustrates a typical configuration of rail system 108 comprising rails and parallel tracks in both X and Y directions.

In the framework structure 100, a majority of the columns 105 are storage columns 105, i.e. columns 105 where storage containers 106 are stored in stacks 107. However, some columns 105 may have other purposes. In FIG. 1, columns 119 and 120 are such special-purpose columns used by the container handling vehicles 201, 301, 401 to drop off and/or pick up storage containers 106 so that they can be transported to an access station (not shown) where the storage containers 106 can be accessed from outside of the framework structure 100 or transferred out of or into the framework structure 100. Within the art, such a location is normally referred to as a ‘port’ and the column in which the port is located may be referred to as a ‘port column’ 119, 120. The transportation to the access station may be in any direction, that is horizontal, tilted and/or vertical. For example, the storage containers 106 may be placed in a random or a dedicated column 105 within the framework structure 100, then picked up by any container handling vehicle and transported to a port column 119, 120 for further transportation to an access station. The transportation from the port to the access station may require movement along various different directions, by means such as delivery vehicles, trolleys or other transportation lines. Note that the term ‘tilted’ means transportation of storage containers 106 having a general transportation orientation somewhere between horizontal and vertical.

In FIG. 1, the first port column 119 may for example be a dedicated drop-off port column where the container handling vehicles 201, 301 can drop off storage containers 106 to be transported to an access or a transfer station, and the second port column 120 may be a dedicated pick-up port column where the container handling vehicles 201, 301, 401 can pick up storage containers 106 that have been transported from an access or a transfer station.

The access station may typically be a picking or a stocking station where product items are removed from or positioned into the storage containers 106. In a picking or a stocking station, the storage containers 106 are normally not removed from the automated storage and retrieval system 1, but are, once accessed, returned into the framework structure 100. A port can also be used for transferring storage containers to another storage facility (e.g. to another framework structure or to another automated storage and retrieval system), to a transport vehicle (e.g. a train or a lorry), or to a production facility.

A conveyor system comprising conveyors is normally employed to transport the storage containers between the port columns 119, 120 and the access station.

If the port columns 119, 120 and the access station are located at different heights, the conveyor system may comprise a lift device with a vertical component for transporting the storage containers 106 vertically between the port column 119, 120 and the access station.

The conveyor system may be arranged to transfer storage containers 106 between different framework structures, e.g. as is described in WO2014/075937A1, the contents of which are incorporated herein by reference.

When a storage container 106 stored in one of the columns 105 disclosed in FIG. 1 is to be accessed, one of the container handling vehicles 201, 301, 401 is instructed to retrieve the target storage container 106 from its position and transport it to the drop-off port column 119. This operation involves moving the container handling vehicle 201, 301 to a location above the storage column 105 in which the target storage container 106 is positioned, retrieving the storage container 106 from the storage column 105 using the container handling vehicle's 201, 301, 401 lifting device (not shown), and transporting the storage container 106 to the drop-off port column 119. If the target storage container 106 is located deep within a stack 107, i.e. with one or a plurality of other storage containers 106 positioned above the target storage container 106, the operation also involves temporarily moving the above-positioned storage containers prior to lifting the target storage container 106 from the storage column 105. This step, which is sometimes referred to as “digging” within the art, may be performed with the same container handling vehicle that is subsequently used for transporting the target storage container to the drop-off port column 119, or with one or a plurality of other cooperating container handling vehicles. Alternatively, or in addition, the automated storage and retrieval system 1 may have container handling vehicles 201, 301, 401 specifically dedicated to the task of temporarily removing storage containers 106 from a storage column 105. Once the target storage container 106 has been removed from the storage column 105, the temporarily removed storage containers 106 can be repositioned into the original storage column 105. However, the removed storage containers 106 may alternatively be relocated to other storage columns 105.

When a storage container 106 is to be stored in one of the columns 105, one of the container handling vehicles 201, 301, 401 is instructed to pick up the storage container 106 from the pick-up port column 120 and transport it to a location above the storage column 105 where it is to be stored. After storage containers 106 positioned at or above the target position within the stack 107 have been removed, the container handling vehicle 201, 301, 401 positions the storage container 106 at the desired position. The removed storage containers 106 may then be lowered back into the storage column 105 or relocated to other storage columns 105.

For monitoring and controlling the automated storage and retrieval system 1, e.g. monitoring and controlling the location of respective storage containers 106 within the framework structure 100, the content of each storage container 106 and the movement of the container handling vehicles 201, 301, 401 so that a desired storage container 106 can be delivered to the desired location at the desired time without the container handling vehicles 201, 301, 401 colliding with each other, the automated storage and retrieval system 1 comprises a control system 500 (shown in FIG. 1) which typically is computerized and which typically comprises a database for keeping track of the storage containers 106.

Regardless of the type of the container handling vehicle, it is desirable to be able to over time gain understanding of the operation of the respective vehicle of the vehicle fleet in a simple and rapid manner. This information could subsequently be used to improve management of the individual vehicles as well as to enhance various aspects of the vehicle fleet management.

Analogously, it should be possible to characterize operation of other parts of the automated storage and retrieval system and subsequently leverage this information as well.

In view of all of the above, it is desirable to provide a solution that solves or at least mitigates one or more of the aforementioned problems belonging to the prior art.

### SUMMARY OF THE INVENTION

The present invention is set forth and characterized in the independent claims, while the dependent claims describe other characteristics of the invention.

A first aspect of the invention relates to a method of operating an automated storage and retrieval system in accordance with claim 1.

On a general level, by calculating electric energy used by the electric motor, a simple metric for facilitating assessing of condition of the motor may be obtained. In the context, all amounts of electric energy used during a given time period by the electric motor are calculated and, based on this and the amount of supplied energy, a degree of utilization of the device comprising the motor is calculated.

Monitoring a degree of utilization of the device over time offers insights into long term performance of the device, as well as a wider system. For instance, any deviation of the value of the degree of utilization could be an indication of device wear and/or that device service is required. Further, a prohibitively poor condition of the device, determined from the calculated degree of utilization of the device, could result in recall or replacement of the device.

In this context, the proposed solution opens for use of predictive maintenance, i.e. to perform device maintenance at the most opportune moment, thus maximizing the useful time of a device while avoiding breakdowns.

In addition, it becomes possible to determine how close to its limit of capacity the device has been used historically. This knowledge opens for more apt management of the device, for instance operating the device close to or, briefly, even above its nominal capacity, provided its operational history justifies it.

In a related context, the advantages conferred on the system level could be improved fleet management, such as device wear levelling, i.e. scheduling use of individual devices in such a manner that the system strives for all devices to have approximately the same wear level whenever possible and/or better fleet management in order to meet an increased demand in peak periods. Still in the context of the advantages conferred on the system level, the invention allows to set aside a number of robots in order to always have available robots with less wear than average.

A second aspect of the invention relates to an automated storage and retrieval system in accordance with claim 17.

For the sake of brevity, advantages discussed above in connection with the method may also be associated with the system and are not further discussed.

For the purposes of this application, the term “container handling vehicle” used in “Background and Prior Art”-section of the application and the term “remotely operated vehicle” used in “Detailed Description of the Invention”-section both define a robotic wheeled vehicle operating on a rail system arranged across the top of the framework structure being part of an automated storage and retrieval system. Analogously, the term “storage container” used in “Background and Prior Art”-section of the application and the term “goods holder” used in “Detailed Description of the Invention”-section both define a receptacle for storing items. In this context, the goods holder can be a bin, a tote, a pallet, a tray or similar. Different types of goods holders may be used in the same automated storage and retrieval system.

The relative terms “upper”, “lower”, “below”, “above”, “higher” etc. shall be understood in their normal sense and as seen in a Cartesian coordinate system. When mentioned in relation to a rail system, “upper” or “above” shall be understood as a position closer to the surface rail system (relative to another component), contrary to the terms “lower” or “below” which shall be understood as a position further away from the rail system (relative another component).

### BRIEF DESCRIPTION OF THE DRAWINGS

Following drawings are appended to facilitate the understanding of the invention. The drawings show embodiments of the invention, which will now be described by way of example only, where:

FIG. 1 is a perspective view of a framework structure of a prior art automated storage and retrieval system.

FIG. 2 is a perspective view of a prior art container handling vehicle having a centrally arranged cavity for carrying storage containers therein.

FIG. 3a is a perspective view of a prior art container handling vehicle having a cantilever for carrying storage containers underneath.

FIG. 3b is a perspective view, seen from below, of a prior art container handling vehicle having an internally arranged cavity for carrying storage containers therein.

FIG. 4 shows an electric circuit representing an electric motor of a device being part of the automated storage and retrieval system.

FIG. 5 is a schematic view of a remotely operated vehicle according to one embodiment of the present invention.

### DETAILED DESCRIPTION OF THE INVENTION

In the following, embodiments of the invention will be discussed in more detail with reference to the appended drawings. It should be understood, however, that the drawings are not intended to limit the invention to the subject-matter depicted in the drawings.

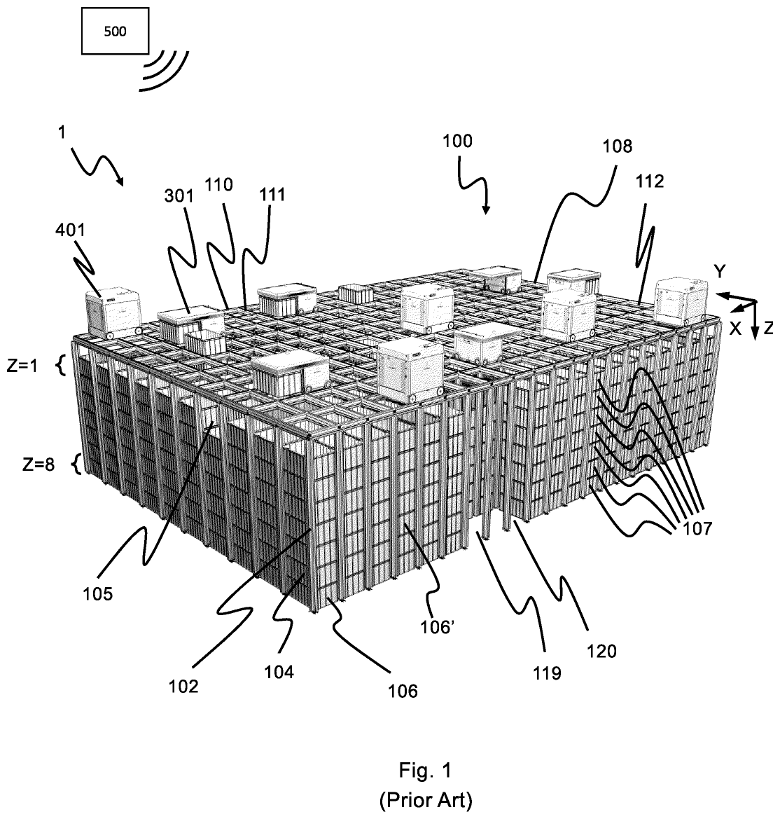

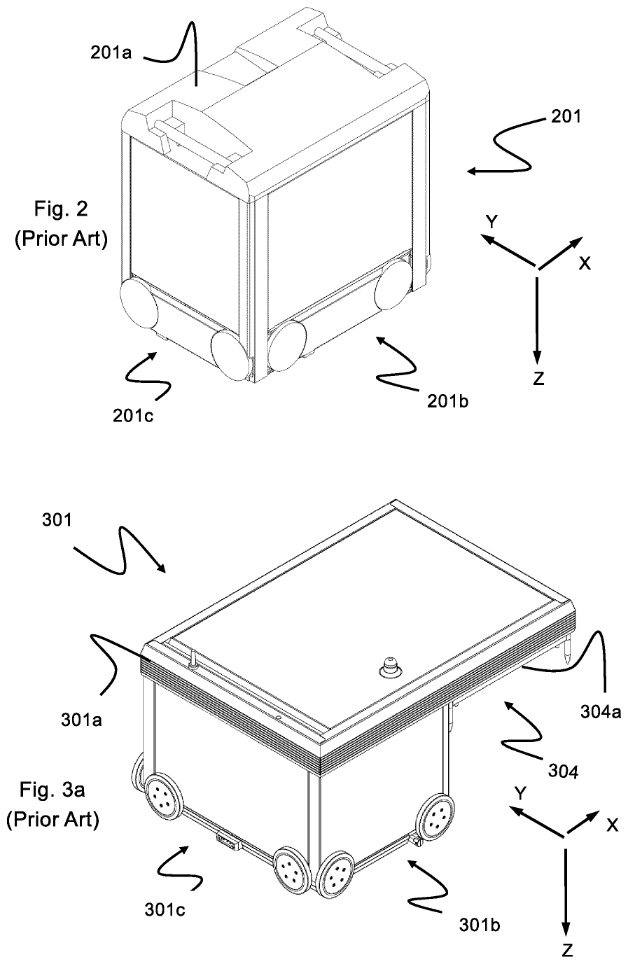

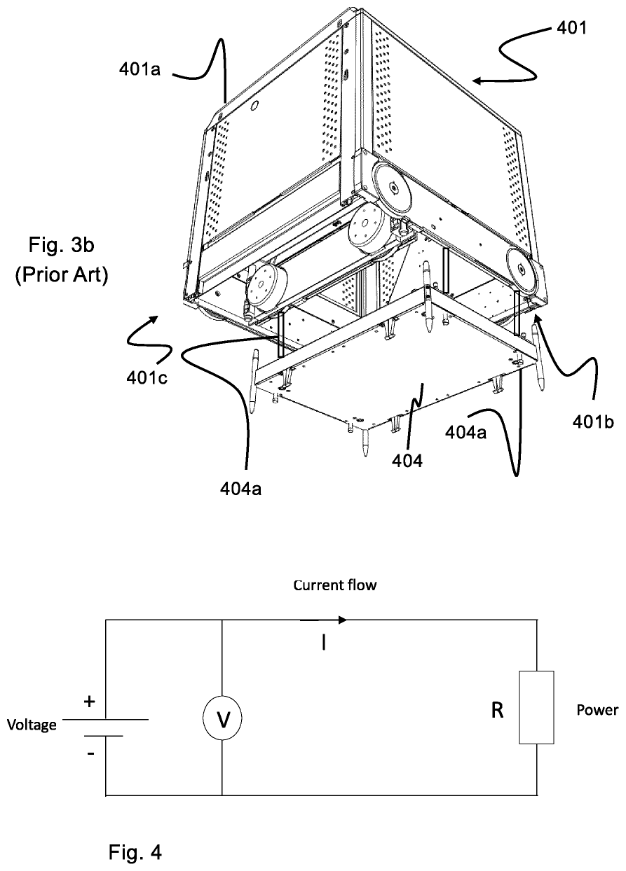

The framework structure 100 of the automated storage and retrieval system 1 is constructed in accordance with the prior art framework structure 100 described above in connection with FIGS. 1-3b, i.e. a number of upright members 102, wherein the framework structure 100 also comprises a first, upper rail system 108 in the X direction and Y direction.

The framework structure 100 further comprises storage compartments in the form of storage columns 105 provided between the members 102 where storage containers 106 are stackable in stacks 107 within the storage columns 105.

The framework structure 100 can be of any size. In particular, it is understood that the framework structure can be considerably wider and/or longer and/or deeper than disclosed in FIG. 1. For example, the framework structure 100 may have a horizontal extent of more than 700×700 columns and a storage depth of more than twelve containers.

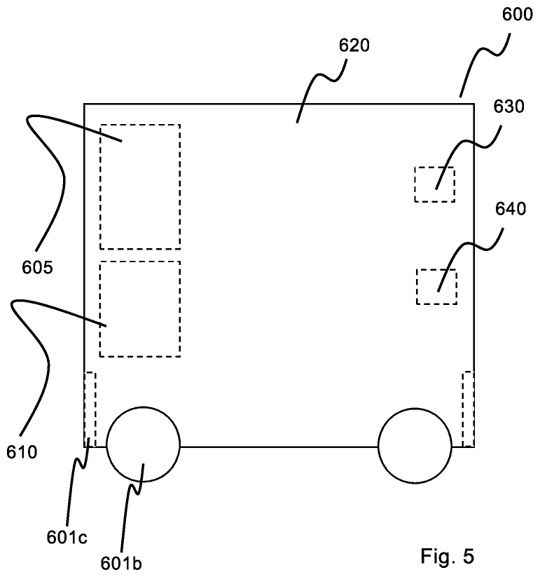

Various aspects of the present invention will now be discussed in more detail with reference to FIGS. 4-5, where FIG. 4 shows an electric circuit representing an electric motor of a device being part of the automated storage and retrieval system 1 shown in FIG. 1.

In one embodiment, energy used by the device is calculated by determining a voltage and a current applied to the operating electric motor of the device. A duration of the operation of said operating electric motor, is also determined. Based on said voltage and current and said duration of the operation, an amount of electric energy used by the electric motor of the device is calculated. Here, applied voltage is typically measured whereas the applied current is estimated. In another, closely related embodiment, energy used is calculated by measuring the applied current and estimating the applied voltage. In yet another related embodiment and with reference to FIG. 4, energy used may be calculated via resistance associated with the electric motor.

A degree of utilization of the above-mentioned device may also be calculated. Degree of utilization is a simple metric, useful for assessing condition of the device. It is calculated by dividing the sum of all calculated amounts of electric energy (used by the electric motor of the device) by a predetermined total amount of electric energy to be supplied during said given time period to said electric motor of the device. Here, the sum of all calculated amounts is obtained by calculating, during a given time period, a plurality of times the amount of electric energy used by said electric motor and summing up all calculated amounts of electric energy used during the given time period by the at least one electric motor of the device. With respect to the total amount of electric energy for the electric motor of the device, said amount may be predetermined or the actual amount supplied to the device may be measured.

Monitoring a degree of utilization of the device over time offers insights into long term performance of the device and of a wider system. For instance, any deviation of the value of the degree of utilization could be an indication of device wear and/or that device service is required. Further, a prohibitively poor condition of the device, derived from the calculated degree of utilization of the device, could result in recall or replacement of the device.

In addition, it becomes possible to determine how close to its limit of capacity the device has been used historically. This knowledge opens for more apt management of the device, for instance operating the device close to or, briefly, even above its nominal capacity, provided its operational history justifies it.

In a preferred embodiment and with reference to FIG. 1, the device is a remotely operated vehicle for handling storage containers operating on a framework-supported rails 108 of the automated storage and retrieval system 1. Such a remotely operated vehicle 600 having an internally arranged cavity 620 is schematically shown in FIG. 5. With reference to FIG. 5, drive means 601b, 601c, for driving in first and second directions, are shown.

The at least one electric motor 605 is a first electric motor of the remotely operated vehicle 600 and the vehicle 600 additionally comprises a second electric motor and a third electric motor, wherein the first electric motor 605 is for driving the remotely operated vehicle in a first direction X, the second electric motor is for driving the remotely operated vehicle in a second direction Y and the third electric motor is for vertical transportation of goods holders.

The electric energy used by each electric motor is supplied from a battery 610 provided aboard said remotely operated vehicle 600 so that a known amount of electric energy is supplied to each electric motor 605 of the remotely operated vehicle 600.

In an embodiment, the value of the electric energy used by the electric motor 605 is calculated in a processing unit 630 of the remotely operated vehicle 600 and stored in a memory unit 640 of the remotely operated vehicle 600. Stored values may be transferred from the memory unit 640 of the remotely operated vehicle 600 to an energy manager (not shown) of the system 1 shown in FIG. 1, either periodically or when requested by the energy manager. In an embodiment, the transfer of stored values takes place while the battery 610 of the remotely operated vehicle 600 is being charged.

Alternatively, the value of the electric energy used by the electric motor 605 may immediately be calculated and stored centrally, e.g. in a memory unit (not shown) belonging to the system 1 of FIG. 1. In this context, the system 1 also comprises said energy manager configured to manage energy use of the remotely operated vehicles of the system. The energy manager runs side-by-side with other software modules of the system 1, such as planning module and routing module.

Still with reference to FIG. 5, in one embodiment, an average degree of utilization of the remotely operated vehicle 600 over given time period is calculated, said average being an exponentially weighted moving average typically calculated over following time periods: 1 h, 8 h, 24 h. Details of this calculation method are well-known to the person skilled in the art. Thus obtained results could serve to evaluate daily operation of the remotely operated vehicle 600. In another, related embodiment, an average degree of utilization of the remotely operated vehicle 600 over given time period is calculated, said average being an exponentially weighted moving average calculated over following time periods: 1 week, 1 month, 1 year. Thus obtained results could serve to facilitate maintenance and service scheduling of the remotely operated vehicle 600.

The calculated average degree of utilization may be used for wear management of a specific remotely operated vehicle 600. More precisely, the previously-described energy manager could make use of the calculated average degree of utilization and send a command to the specific vehicle 600 to reduce or increase its activity.

In a related embodiment, the energy manager could also make use of the calculated average degree of utilization in order to determine condition of the remotely operated vehicle 600. More specifically, historical operation data is typically used to establish a baseline value of degree of utilization for the remotely operated vehicle 600. The calculated average degree of utilization is compared to the baseline value of degree of utilization. Based on the outcome of the comparison, condition of the remotely operated vehicle 600 is determined. In addition, and based on the condition of the vehicle 600, predictive maintenance may be used to schedule maintenance of the vehicle 600. Accordingly, vehicle maintenance may be performed at the most opportune moment, thus maximizing the useful time of a vehicle 600 while avoiding breakdowns.

In an embodiment, information regarding said known amount of electric energy supplied to each electric motor 605 of the remotely operated vehicle 600 may be retrieved from existing log files of the automated storage and retrieval system 1. Here, a log file is a computer-generated data file that contains information about activities and operations within the system 1, for instance information regarding energy level of the battery 610 of the remotely operated vehicle 600 of FIG. 5.

Obviously, benefits associated with the invention may be bestowed upon devices other than remotely operated vehicles. By way of example, different types of ports, such as conveyor ports, swing ports and carousel ports may be considered.

In yet another embodiment, a condition of the battery 610 of the remotely operated vehicle 600 may be calculated by dividing the total amount of electric energy supplied by said battery 610 during one battery discharge cycle by the nominal capacity value of said battery. Nominal capacity of the battery should be continuously suitably adjusted to reflect the current state of the battery, including its performance degradation.

Using the calculated average degree of utilization over said given time period of each device, e.g. remotely operated vehicle or port, being part of the system 1 enables to calculate average degree of utilization of the entire system 1 over said given time period. In its simplest form such a calculation comprises simply averaging the calculated individual device (remotely operated vehicle, port . . . ) values. The hereby conferred systemic advantages are improved fleet management, such as device wear levelling, i.e. scheduling use of individual devices in such a manner that the system strives for all devices to have approximately the same wear level whenever possible and/or better fleet management in order to meet an increased demand in peak periods. At least some of data handling in connection with the fleet management is performed by the energy manager.

The following clauses describe the developments mentioned above from another aspect, to serve as basis for future divisional applications or amendments.

1. A method of maintaining an automated storage and retrieval system comprising a plurality of robots, the method comprising using each of the plurality of robots to calculate a respective accumulated energy usage, and maintaining the system based upon the plurality of calculated accumulated energy usages.

Thus, each robot calculates its own energy usage, which is simple and easy to do. The accumulated energy usage may be calculated for a predetermined period.

2. A method as recited in clause 1, wherein each robot comprises a processor, the method comprising using the processor of each robot to calculate the respective accumulated energy usage.

3. A method as recited in clause 1 or 2, wherein each robot comprises a memory, the method comprising storing each calculated accumulated energy usage in the respective memory.

4. A method as recited in any preceding clause, comprising transferring the calculated accumulated energy usage to a central controller of the automated storage and retrieval system.

For example, the calculated accumulated energy usage may be transferred from the memory of each robot to an energy manager of the central controller. The transfer may be done at regular intervals, upon satisfaction of predetermined conditions (e.g. distance travelled, containers carried etc.), while the robot is charging, and so on.

5. A method as recited in any preceding clause, comprising determining a utilisation value of one of the plurality of robots based on its calculated accumulated energy usage.

Determining the utilisation value may comprise comparing the calculated accumulated energy usage of a robot to a baseline value (e.g. a baseline energy usage) and e.g. thereby calculating the relative energy usage of the robot for a predetermined period. In this way, it is possible to compare a robot's energy usage for different periods, and hence determine if its energy usage has changed, which may indicate that the robot requires maintenance, that it is operating at full load, or it is operating and above maximum load (risking premature wear of components) etc.

6. A method as recited in any preceding clause, comprising determining a utilisation value of the system based on the calculated accumulated energy usages of the plurality of the robots.

The method may comprise altering operation of the system (e.g. of at least one of the plurality of robots) to improve efficiency, level wear, etc.

7. A method as recited in any preceding clause, comprising determining a baseline utilisation value for a robot and/or the system.

Determining the baseline may include collecting historical data and using that. It may include estimating an energy usage. The method may include updating the baseline based on new data.

8. A method as recited in any preceding clause, wherein maintaining the system comprises performing maintenance upon a robot.

9. A method as recited in any preceding clause, comprising commanding at least one of the plurality of robots in order to maintain the automated storage and retrieval system.

10. A method as recited in any preceding clause, wherein the accumulated energy usage comprises the energy usage of a motor of the robot.

The accumulated energy usage may comprise the energy usage of a plurality of motors of the robot e.g. first, second and third motors as described herein. The accumulated energy usage may comprise only the energy usage of the first, second and third motors, which may be sufficient to provide a meaningful indication of the load of the respective robot, and hence of the system.

11. A method as recited in clause 10, comprising:
measuring a voltage and/or current applied to the motor of the robot, and using the measured voltage and/or current to calculate the accumulated energy usage by the motor.

In the preceding description, various aspects of the invention have been described with reference to the illustrative embodiment. For purposes of explanation, specific numbers, systems and configurations were set forth in order to provide a thorough understanding of the system and its workings. However, this description is not intended to be construed in a limiting sense. Various modifications and variations of the illustrative embodiment, as well as other embodiments of the system, which are apparent to persons skilled in the art to which the disclosed subject matter pertains, are deemed to lie within the scope of the present invention.

### LIST OF REFERENCE NUMBERS

1 System
100 Framework structure
102 Upright members of framework structure
104 Storage grid
105 Storage column
106 Storage container/goods holder
106′ Particular position of storage container
107 Stack of storage containers
108 Rail system
110 Parallel rails in first direction (X)
111 Parallel rails in second direction (Y)
112 Access opening
119 First port column
201 Container handling vehicle belonging to prior art
201a Vehicle body of the container handling vehicle 201
201b Drive means/wheel arrangement, first direction (X)
201c Drive means/wheel arrangement, second direction (Y)
301 Cantilever-based container handling vehicle belonging to prior art
301a Vehicle body of the container handling vehicle 301
301b Drive means in first direction (X)
301c Drive means in second direction (Y)
401 Container handling vehicle belonging to prior art
401a Vehicle body of the container handling vehicle 401
401b Drive means in first direction (X)
401c Drive means in second direction (Y)
404a Lifting bands
600 Remotely operated vehicle
601b Drive means in first direction (X)
601c Drive means in first direction (Y)
605 Engine
610 Battery
620 Cavity
630 Processing unit
640 Memory unit
X First direction
Y Second direction
Z Third direction

1. A method for calculating a degree of utilization of a device (600) of an automated storage and retrieval system, the method comprising the steps of:
determining a voltage applied to a motor (605) of the device (600),
determining a current applied to the motor (605),
determining a duration of operation of the motor (605),
based on the voltage, current, and duration of operation, calculating an amount of energy used by the motor (605) of the device (600), and
based on the calculated amount of energy, calculating the degree of utilization of the device (600).

2. Method of claim 1, said method comprising the steps of:
during a given time period, calculating a plurality of times the amount of energy used by the motor (605),
summing up all calculated amounts of energy used during the given time period by the motor (605), and
calculating the degree of utilization of the device (600) by dividing the sum of all calculated amounts of energy by a predetermined total amount of energy to be supplied during the given time period to the motor (605).

3. Method of claim 1, said method comprising the steps of:
during a given time period, calculating a plurality of times the amount of energy used by the motor (605),
summing up all calculated amounts of energy consumed during the given time period by the motor (605) of the device (600), and
calculating the degree of utilization of the device (600) by dividing the sum of all calculated amounts of energy by a total amount of electric energy supplied during the given time period to the motor (605).

4. Method of claim 2, wherein the device (600) is a remotely operated vehicle (603) for handling goods holders (106) operating on a framework-supported rail system (108) of the automated storage and retrieval system (1), wherein the motor (605) is a first electric motor and the vehicle (603) comprises a second electric motor and a third electric motor, wherein the first electric motor (605) is for driving the remotely operated vehicle (603) in a first direction X, the second electric motor is for driving the remotely operated vehicle (603) in a second direction Y and the third electric motor is for vertical transportation of goods holders (106), wherein the energy used by each electric motor is supplied from a battery (610) provided aboard the remotely operated vehicle (603) so that a known amount of energy is supplied to each electric motor (605) of the remotely operated vehicle (603).

5. Method of claim 1, wherein the value of the energy used by the motor (605) is calculated in a processing unit (630) of a remotely operated vehicle (603) and stored in a memory unit (640) of the remotely operated vehicle (603).

6. Method of claim 5, wherein stored values are transferred from the memory unit (640) while a battery (610) of the remotely operated vehicle (603) is being charged.

7. Method of claim 1, wherein the method comprises the step of:
calculating an average degree of utilization of said device (600) over said given time period, wherein said average is an exponentially weighted moving average.

8. Method of claim 7, wherein said exponentially weighted moving average is calculated over following time periods: 1 h, 8 h, 24 h.

9. Method of claim 7, wherein said exponentially weighted moving average is calculated over following time periods: 1 week, 1 month, 1 year.

10. Method of claim 7, wherein the calculated average degree of utilization is used for wear management of the device (600), and wherein the method comprises the step of:
sending a command to said device (600) to reduce or increase its activity.

11. Method of claim 7, wherein the calculated average degree of utilization is used to determine condition of the device (600), and wherein the method comprises the steps of:
using historical device operation data to establish a baseline value of degree of utilization,
comparing the calculated average degree of utilization to the baseline value of degree of utilization,
based on the outcome of the comparison, determining condition of the device (600).

12. Method of claim 11, wherein the method comprises the steps of:
based on the condition of the device (600), using predictive maintenance to schedule maintenance of the device (600).

13. Method of claim 4, wherein information regarding said known amount of energy supplied to each electric motor (605) of the remotely operated vehicle (603) is retrieved from log files of the automated storage and retrieval system (1).

14. Method of claim 4, wherein a condition of the battery (610) of the remotely operated vehicle (603) is calculated by dividing the total amount of electric energy supplied by said battery (610) during one battery discharge cycle by a nominal capacity value of said battery (610).

15. Method of claim 7, wherein the method comprises the step of:
using the calculated average degree of utilization over said given time period of each device (600) being part of the automated storage and retrieval system (1), wherein the calculated average degree of utilization over the given time period of each device is an exponentially weighted moving average, to calculate average degree of utilization of said automated storage and retrieval system (1) over said given time period, wherein the average degree of utilization of the automated storage and retrieval system is an exponentially weighted moving average.

16. A remotely operated vehicle (603) comprising an energy manager configured to manage energy use of said remotely operated vehicle (603) operating on a rail system (108) of an automated storage and retrieval system (1), the energy manager configured to:
determine a voltage applied to a motor (605) of the vehicle (603),
determine a current applied to the motor (605),
determine a duration of operation of the motor (605),
based on the voltage, the current, and the duration of operation, calculate an amount of energy used by the motor (605), and
based on the calculated amount of energy, calculate a degree of utilization of the vehicle (603).

17. An automated storage and retrieval system (1) comprising:
a framework structure (100) that comprises a plurality of storage columns (105) for storing goods holders (106), and
a rail system (108) arranged across a top of the framework structure (100),
wherein said system (1) comprises an energy manager configured to manage energy use of a device (600), such as the device (600) being a remotely operated vehicle (603), the energy manager configured to:
determine a voltage applied to a motor (605) of the vehicle (603),
determine a current applied to the motor (605),
determine a duration of operation of the motor (605),
based on the voltage, the current, and the duration of operation, calculate an amount of energy used by the motor (605), and
based on the calculated amount of energy, calculate a degree of utilization of the vehicle (603).

18. An apparatus for calculating a degree of utilization of a device (600) of an automated storage and retrieval system, the apparatus configured to:
determine a voltage applied to a motor (605) of the device (600),
determine a current applied to the motor (605),
determine a duration of operation of the motor (605),
based on the voltage, the current, and the duration of operation, calculate an amount of energy used by the motor (605), and
based on the calculated amount of energy, calculate the degree of utilization of the device (600).

19. The apparatus of claim 18, further configured to:
during a given time period, perform, a plurality of times, the calculating of an amount of energy used by the motor (605),
sum up all calculated amounts of energy used during the given time period by the motor (605), and
calculate the degree of utilization of the device (600) by dividing the sum of all calculated amounts of energy by a predetermined total amount of energy to be supplied during the given time period to the motor (605).

20. The apparatus of claim 18, further configured to:
during a given time period, perform, a plurality of times, the calculating of an amount of energy used by the motor (605),
sum up all calculated amounts of energy consumed during the given time period by the motor (605), and
calculate the degree of utilization of the device (600) by dividing the sum of all calculated amounts of energy by a total amount of electric energy supplied during the given time period to the motor (605).
